(19) United States
(12) Patent Application Publication
(10) Pub. No.: US 2019/0321854 A1
(43) Pub. Date: Oct. 24, 2019

(54) ELONGATED POLYGON-SHAPED ELECTRICALLY ACTIVE MATERIAL LAYER FOR ULTRASONIC TRANSDUCER

(71) Applicant: uBeam Inc., Santa Monica, CA (US)

(72) Inventors: Iman Shahosseini, Woodland Hills, CA (US); Zuki Tanaka, Culver City, CA (US)

(21) Appl. No.: 15/961,205

(22) Filed: Apr. 24, 2018

(51) Int. Cl. B06B 1/06; G10K 13/00

(52) U.S. Cl. CPC B06B 1/067; G10K 13/00; B06B 1/0666

(57) ABSTRACT

An apparatus of the disclosure is directed to an elongated polygon-shaped transducer elastic layer having a first plurality of edges, a first plurality of vertices, and a first electrical connection at one of the first plurality of vertices. The apparatus includes an elongated polygon-shaped electrically active material layer having a second plurality of edges, a second plurality of vertices, and a second electrical connection at one of the second plurality of vertices, where the elongated polygon-shaped electrically active material layer is disposed on the elongated polygon-shaped transducer elastic layer to transform electrical excitation into a high-frequency vibration to produce ultrasonic acoustic emissions or transform received high-frequency acoustic vibration into electrical signals. The elongated polygon-shaped transducer elastic layer and the elongated polygon-shaped electrically active material layer may be hexagonal.

### BACKGROUND

Ultrasonic transducers receive acoustic energy at ultrasonic frequencies as an input and provide electrical energy as an output, or receive electrical energy as an input and provide acoustic energy at ultrasonic frequencies as an output. An ultrasonic transducer can include a piece of piezoelectric material that changes size in response to the application of an electric field. If the electric field is made to change at a rate comparable to ultrasonic frequencies, then the piezoelectric element can vibrate and generate acoustic pressure waves at ultrasonic frequencies. Likewise, when the piezoelectric element resonates in response to impinging ultrasonic energy, the element can generate electrical energy.

### BRIEF SUMMARY

Implementations of the disclosed subject matter provide an apparatus that may include an elongated hexagon-shaped transducer elastic layer having a first plurality of edges, a first plurality of vertices, and a first electrical connection at one of the first plurality of vertices. The apparatus may include an elongated hexagon-shaped piezoelectric layer having a second plurality of edges, a second plurality of vertices, and a second electrical connection at one of the second plurality of vertices. The elongated hexagon-shaped piezoelectric layer may be disposed on the elongated hexagon-shaped transducer elastic layer to transform electrical excitation into a high-frequency vibration to produce ultrasonic acoustic emissions or transform received high-frequency acoustic vibration into electrical signals. A thickness of the elongated hexagon-shaped piezoelectric layer may be 0.05-0.50 mm. A length of at least one surface dimension of the elongated hexagon-shaped piezoelectric layer may be 0.2-20 mm.

Implementations of the disclosed subject matter provide an apparatus that may include an elongated polygon-shaped transducer elastic layer having a first plurality of edges, a first plurality of vertices, and a first electrical connection at one of the first plurality of vertices. The apparatus may include an elongated polygon-shaped electrically active material layer having a second plurality of edges, a second plurality of vertices, and a second electrical connection at one of the second plurality of vertices. The elongated polygon-shaped electrically active material layer may be disposed on the elongated polygon-shaped transducer elastic layer to transform electrical excitation into a high-frequency vibration to produce ultrasonic acoustic emissions or transform received high-frequency acoustic vibration into electrical signals.

Additional features, advantages, and embodiments of the disclosed subject matter may be set forth or apparent from consideration of the following detailed description, drawings, and claims. Moreover, it is to be understood that both the foregoing summary and the following detailed description are examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1A shows an example of a conical structure coupled to an elongated polygon-shaped transducer elastic layer and an elongated polygon-shaped electrically active material of an ultrasonic transducer according to an implementation of the disclosed subject matter.

FIG. 1B shows a bottom view of an example ultrasonic transducer according to an implementation of the disclosed subject matter.

FIGS. 2A-2B show a conical structure coupled to an elongated polygon-shaped electrically active material layer according to implementations of the disclosed subject matter.

FIG. 3 shows an example elongated polygon-shaped electrically active material of an ultrasonic transducer according to an implementation of the disclosed subject matter.

FIG. 4 shows a bottom view of an example an ultrasonic transducer that includes an elongated polygon-shaped transducer elastic layer and an elongated polygon-shaped electrically active material according to an implementation of the disclosed subject matter.

FIG. 5 shows a side view of an example an ultrasonic transducer that includes an elongated polygon-shaped transducer elastic layer and an elongated polygon-shaped electrically active material according to an implementation of the disclosed subject matter.

FIG. 6 shows a bottom view of an example an ultrasonic transducer that includes an elongated polygon-shaped transducer elastic layer and an elongated polygon-shaped electrically active material according to an implementation of the disclosed subject matter.

FIGS. 7A-7B show electrically conductive members coupled to an elongated polygon-shaped transducer elastic layer and an elongated polygon-shaped electrically active material according to implementations of the disclosed subject matter.

FIG. 8 shows an example of a transducer array according to an implementation of the disclosed subject matter.

### DETAILED DESCRIPTION

Implementations of the disclosed subject matter provide a conical structure coupled to an ultrasonic transducer. The transducer may include an elongated polygon-shaped transducer elastic layer having a first plurality of edges, a first plurality of vertices, and a first electrical connection at or near one of the first plurality of vertices. The transducer may include an elongated polygon-shaped electrically active material layer having a second plurality of edges, a second plurality of vertices, and a second electrical connection at or near one of the second plurality of vertices, wherein the elongated polygon-shaped electrically active material layer is disposed on the elongated polygon-shaped transducer elastic layer to transform electrical excitation into a high-frequency vibration to produce ultrasonic acoustic emissions or transform received high-frequency acoustic vibration into electrical signals. In some implementations, properties of the transducer may be adjusted so as to provide acoustic matching between the operating medium (e.g., air) and the transducer.

In implementations of the disclosed subject matter, the elongated polygon-shaped transducer elastic layer may be an elongated hexagon-shaped transducer elastic layer, and the elongated polygon-shaped electrically active material layer may be an elongated hexagon-shaped piezoelectric layer. The elongated hexagon-shaped piezoelectric layer may be disposed on the elongated hexagon-shaped transducer elastic layer to transform electrical excitation into a high-frequency vibration to produce ultrasonic acoustic emissions or transform received high-frequency acoustic vibration into electrical signals.

Implementations of the disclosed subject matter provide a conical structure and a transducer that includes elongated polygon-shaped transducer elastic layer and the elongated polygon-shaped electrically active material layer to increase acoustic pressure of a transmitted ultrasonic wave and/or maximize the signal-to-noise ratio of a received ultrasonic signal, so that an electric signal with decreased noise may be obtained by a receiving device for processing. That is, implementations of the disclosed subject matter provide a transducer having elongated polygon-shaped transducer elastic layer and the elongated polygon-shaped electrically active material layer to generate maximum power from input signals. The transducer having the elongated polygon-shaped transducer elastic layer and the elongated polygon-shaped electrically active material layer may generate a useable signal (even from received low-amplitude signals), regardless of the signal-to-noise ratio of the received signal. In the apparatus of the disclosed subject matter, the stiffness of the elongated polygon-shaped transducer elastic layer and the elongated polygon-shaped electrically active material layer of the transducer may be adjusted to tune the working frequency (e.g., to increase the amount of energy harvested) and to provide acoustic matching between the operating medium (e.g., air) and the transducer.

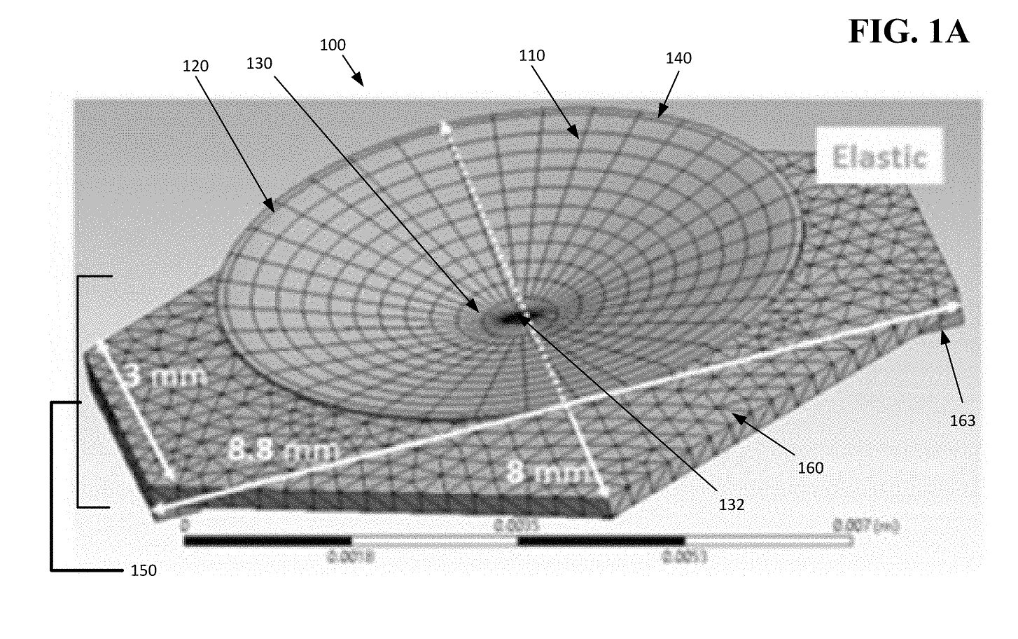

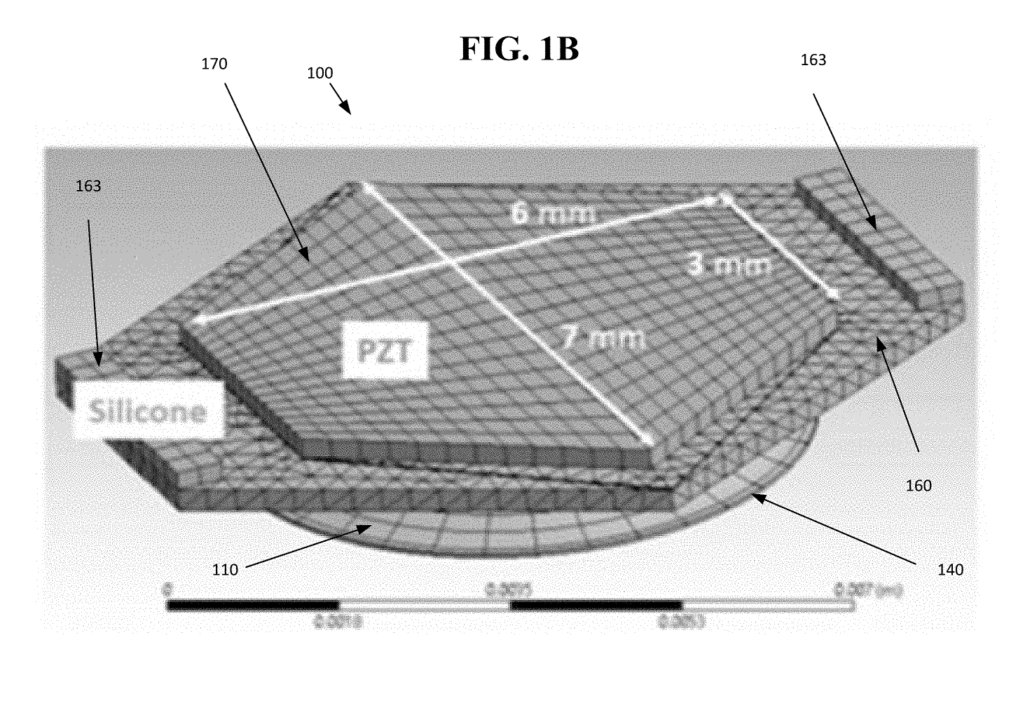

FIG. 1A shows an example of a conical structure coupled to an elongated polygon-shaped transducer elastic layer and an elongated polygon-shaped electrically active material of an ultrasonic transducer. An apparatus 100 may include a conical structure 110 that has a first circumference 120 and a second circumference 130, that are respectively located at opposite ends of the conical structure 110. The conical structure 110 may be formed from steel, stainless steel, aluminum, plastic, carbon fiber composite, or any other suitable material. The conical structure 110 may be formed through any suitable additive or subtractive processes. A rim 140 may be coupled at or adjacent to the first circumference 120 of the conical structure 110. That is, the surface area of the conical structure 110 may be adjusted by adding the rim 140 to a portion of the conical structure 140. The surface area of the conical structure 110 may be adjusted by varying the angle between the first and second circumferences 120, 130 of the conical structure 110, as well as the height and/or the width of the rim 140 attached to the conical structure 110. These features of the conical structure 110 may be adjusted so as to maximize the surface area to capture as much of an incident ultrasonic wave as possible and generate a useable signal. The rim 140 may be formed structurally with the conical structure 110 through the additive or subtractive process. In some implementations, the rim 140 may be formed separately, and then welded, soldered, affixed (e.g., using an adhesive), and/or coupled in any suitable manner to the conical structure 110. The type of coupling used may be selected based on, for example, the type of material used to form the conical structure 110 and/or the rim 140.

In some implementations, at least one of the circumferences 120, 130 that defines an opening of the conical structure 110 may be adjusted from a circle shape to an oval shape so as to adjust the focus of the conical structure 110 for a transmitted signal or a received ultrasonic signal. In some implementations, at least one of the circumferences 120, 130 that defines an opening of the conical structure 110 may be adjusted to have a polygon shape. The sidewalls disposed between the circumferences that define the openings of the conical structure may be formed in a planar shape, a convex shape, or a concave shape to adjust the focus of the conical structure for a transmitted signal or a received ultrasonic signal.

The first circumference 120 and the second circumference 130 may be any suitable length. In some implementations, the first circumference of the conical structure 110 may have a length that is 5-10 mm, 10-15 mm, 15-20 mm, 20-25 mm, or 25-30 mm. In some implementations, the first circumference of the conical structure 110 may have a length that is 15-25 mm. The second circumference of the conical structure 110 may have length that is 1-2 mm, 2-3 mm, 3-4 mm, or 4-5 mm. In some implementations, the second circumference of the conical structure 110 may have length that is 2-4 mm.

In some implementations, the first circumference 120 and the second circumference 130 may each form openings respectively located at opposite ends of the conical structure 110. In some implementations, a second opening may be formed in at least a portion of the area of the second circumference 130 to form a hole. In some implementations, a covering may be formed over the opening formed by the second circumference 130.

The rim 140 of the conical structure 110 shown in FIG. 1A may have a height of 10-30 μm, 30-50 μm, 50-70 μm, 70-90 μm, 90-110 μm, 110-130 μm, 130-150 μm, 150-170 μm, 170-190 μm, or 190-210 μm, or any other suitable height. In some implementations, the height of the rim 140 may be 25-110 μm. The height of the rim 140 may be the same as the thickness of the conical structure 110. The thickness of the conical structure 110 may be 10-30 μm, 30-50 μm, 50-70 μm, 70-90 μm, 90-110 μm, 110-130 μm, 130-150 μm, 150-170 μm, 170-190 μm, or 190-210 μm, or any other suitable thickness. In some implementations, the thickness of the rim 140 may be 25-110 μm. A width of the rim 140 may be 0-0.1 mm, 0.1 mm-0.2 mm, 0.2-0.4 mm, and 0.4-0.5 mm, 0.5-0.6 mm, 0.6-0.7 mm, 0.7 mm-0.8 mm, or 0.9-1.0 mm, or any other suitable width. In some implementations, the width of the rim 140 may be 0.01-0.2 mm. The width of the rim may be a distance from an inner rim circumference to an outer rim circumference. An inner rim circumference may correspond to that of the first circumference 120 of the conical structure 110.

A distance between the first circumference 120 and the second circumference 130 may be 0.1-0.3 mm, 0.3-0.7 mm, 0.7-1.1 mm, or 1.1-1.5 mm. In some implementations, the distance may be 0.7-1.2 mm. The first circumference 120 may have a greater length than the second circumference 130. An angle between the second circumference 130 and the first circumference 120 may be between a plane including the second circumference 130 and a surface of the conical structure 110 and, in some implementations, may variably increase. In implementations of the disclosed subject matter, the angle may be 150°-170°, or any other suitable angle. The wider angle of the conical structure 110 may maximize the surface area to capture as much of an incident ultrasonic wave as possible and generate a useable signal.

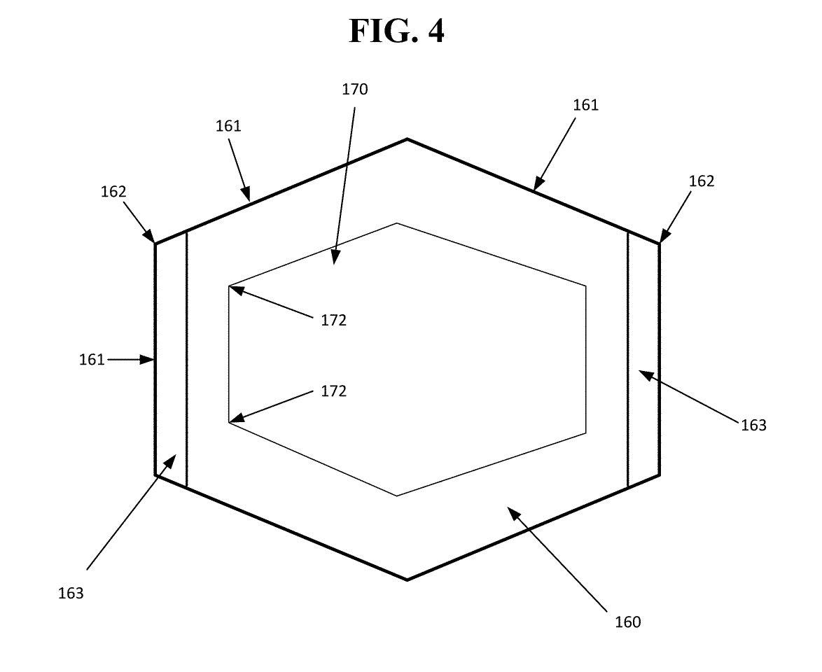

The second circumference 130 of the conical structure 110 may be coupled an ultrasonic transducer 150, which may include an elongated polygon-shaped transducer elastic layer 160 and elongated polygon-shaped electrically active material layer 170, for example, as shown in FIG. 1B. Attachment points 163 (e.g., silicone or the like) may be disposed on a bottom surface of the elongated polygon transducer membrane 160 (as shown in FIG. 1B), and may be used to attach transducer 150 to a base or other support structure. In some implementations, the attachment points 163 may be disposed on a top surface of the elongated polygon transducer membrane 160. In some implementations, the elongated polygon-shaped transducer elastic layer 160 may be an elongated hexagon transducer elastic layer having a perimeter comprising six edges and six vertices. The elongated hexagon transducer elastic layer may be fixed to a support structure (e.g., support structure 163, as shown in FIG. 4) at or around two vertices of the six vertices that are most distant from each other and not fixed at the other vertices or the edges of the perimeter. By attaching the elongated polygon transducer membrane 160 at the attachment points, the efficiency of the ultrasonic transducer 150 may be increased by two or three times over an arrangement where the elongated polygon transducer membrane 160 is attached around the perimeter. Increased deflection of the ultrasonic transducer 150 may occur, and the arrangement may provide increased acoustic matching between the operating medium (e.g., air) and the transducer. That is, the ultrasonic transducer 150 may increase acoustic pressure of a transmitted ultrasonic wave and/or maximize the signal-to-noise ratio of a received ultrasonic signal so that the ultrasonic transducer 150 may generate maximum power from input signals.

The ultrasonic transducer 150 may be coupled to the conical structure 110 by applying an adhesive, bonding, welding, or soldering, and/or may be coupled in any other suitable manner. The type of coupling used may be selected based on, for example, the type of material used to form the conical structure 110.

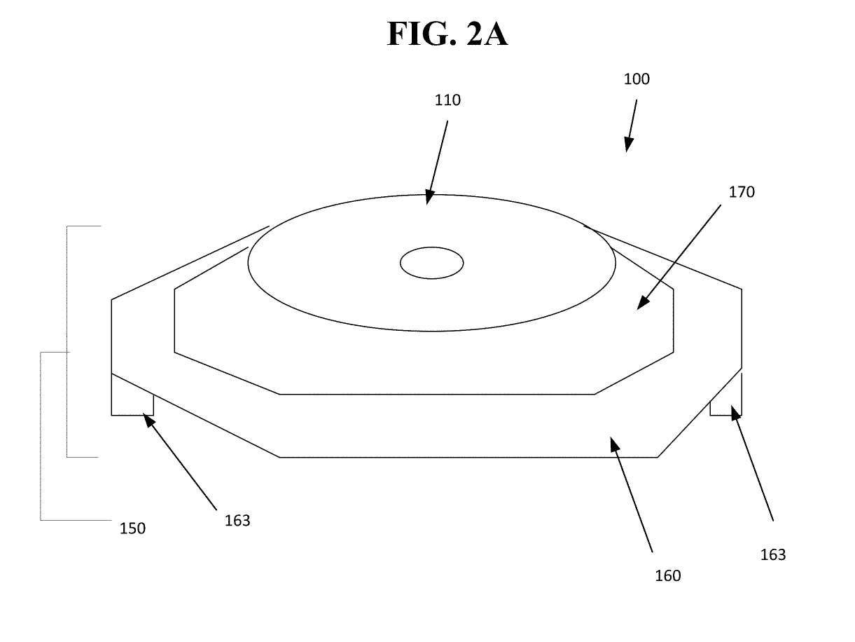

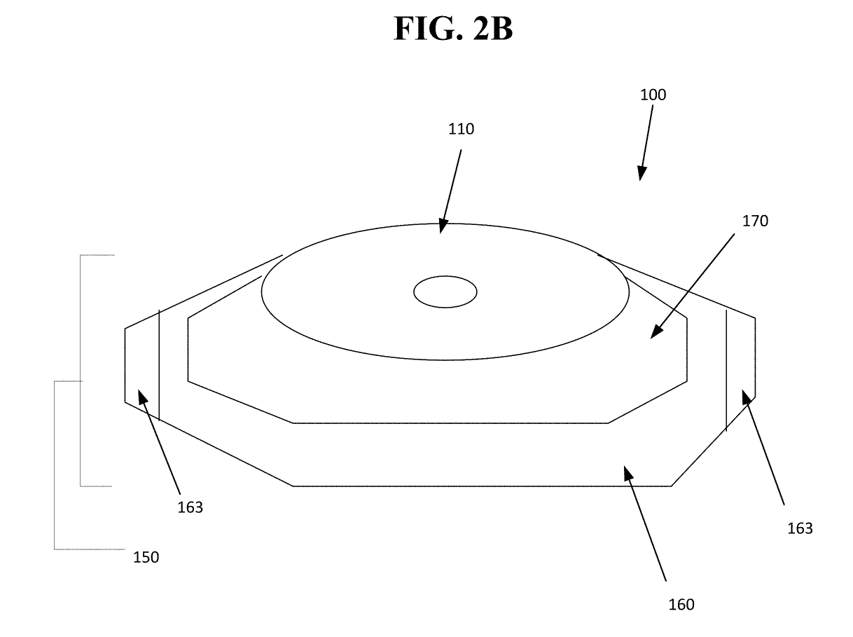

FIGS. 1A-1B show the conical structure 110 coupled to the elongated polygon transducer membrane 160, with elongated polygon-shaped electrically active material layer 170 disposed on the bottom of the elongated polygon transducer membrane 160 according to implementations of the disclosed subject matter. In some implementations, such as shown in FIGS. 2A-2B, the conical structure 110 may be coupled to the elongated polygon-shaped electrically active material layer 170, and the elongated polygon transducer membrane 160 may be disposed on the bottom of the elongated polygon-shaped electrically active material layer 170. In FIG. 2A, the attachment points 163 may be disposed on a bottom surface of the elongated polygon transducer membrane 160, and may be used to attach transducer 150 to a base or support structure. In some implementations, as shown in FIG. 2B, the attachment points 163 may be disposed on a top surface of the elongated polygon transducer membrane 160.

FIG. 1B shows a bottom view of the apparatus 100 of FIG. 1A according to an implementation of the disclosed subject matter. The ultrasonic transducer 150 of the apparatus 100 may include the elongated polygon-shaped electrically active material layer 170 that may be disposed on the elongated polygon-shaped transducer elastic layer 160 to transform electrical excitation into a high-frequency vibration to produce ultrasonic acoustic emissions or transform received high-frequency acoustic vibration into electrical signals. The polygon-shaped transducer elastic layer 160 may have a first surface and a second surface, and may be coated on at least one of the first surface and the second surface with an electrically conductive material. The electrically conductive material may be gold, copper, aluminum, or any other suitable conductive material.

In some implementations, the elongated polygon-shaped transducer elastic layer 160 may include ribs or patterns disposed on a surface of the elongated polygon-shaped transducer elastic layer 160. The ribs or patterns may be disposed on the surface of the elongated polygon-shaped transducer elastic layer so as to be staggered, where each shape of the rib or the pattern is spaced a predetermined distance away from the adjacent shape in the rib or pattern. The ribs or patterns may be formed through any suitable additive or subtractive processes. The ribs or patterns may be etched into the elongated polygon-shaped transducer elastic layer 160. In some implementations, the rib or pattern may be molded or coupled to the elongated polygon-shaped transducer elastic layer 160. The ribs or patterns may be bonded, welded, soldered, fixed (e.g., with an adhesive), or coupled in any suitable manner to the elongated polygon-shaped transducer elastic layer 160. In some implementations, the ribs or patterns may be integrally formed with the elongated polygon-shaped transducer elastic layer 160 through any suitable additive or subtractive processes. The ribs or patterns may have a thickness, profile, structure, arrangement, and/or placement so as to increase the rigidity of the elongated polygon-shaped transducer elastic layer 160. Adjusting the rigidity of the elongated polygon-shaped transducer elastic layer 160, such as with the ribs or patterns, may at least partially acoustically match the operating medium (e.g., air) and the transducer 150, as well as to assist the transducer 150 in increasing the signal-to-noise ratio so that the transducer 150 may generate a useable signal even from received low-amplitude signals.

The ultrasonic transducer 150, shown in FIGS. 1A-2B, may receive an electrical control signal (a “driving signal”), causing the elongated polygon-shaped electrically active material layer 170 (e.g., a flexure to bend and/or the tip) to vibrate relative to its base at or around ultrasonic frequencies. The elongated polygon-shaped electrically active material layer 170 can be in direct or indirect communication with the elongated polygon-shaped transducer elastic layer 160, and can cause the elongated polygon-shaped transducer elastic layer 160 to vibrate and create ultrasonic frequency acoustic waves.

The ultrasonic transducer 150 may include an electromechanically active device, such as the elongated polygon-shaped electrically active material layer 170. The elongated polygon-shaped electrically active material layer 170 may be a cantilever or flexure, and may be, for example, a piezoceramic unimorph, bimorph, or trimorph. The elongated polygon-shaped electrically active material layer 170 may include an electrically active material, such as piezoelectric material or piezo-ceramic, electrostrictive material, or ferroelectric material, which may able to transform electrical excitation into a high-frequency vibration to produce ultrasonic acoustic emissions. The geometry of an elongated polygon-shaped electrically active material layer 170 may affect the frequency, velocity, force, displacement, capacitance, bandwidth, and efficiency of electromechanical energy conversion produced by the electromechanically active device when driven to output ultrasound and the voltage and current generated by the elongated polygon-shaped electrically active material layer 170 and efficiency of electromechanical energy conversion when driven by received ultrasound. The elongated polygon-shaped electrically active material layer 170 may have a hexagonal profile, or may have a profile based on any other suitable geometry. The geometry of the elongated polygon-shaped electrically active material layer 170 may be selected, for example, to tune the balance and other various characteristics of the elongated polygon-shaped electrically active material layer 170. The elongated polygon-shaped electrically active material layer 170 may be made using single layer of piezoelectric material laminated onto a single passive substrate material. The elongated polygon-shaped electrically active material layer 170 may also be made with a single piezoelectric layer and multiple passive layers; two piezoelectric layers operating anti-phase or in-phase, or two piezoelectric layers, operating anti-phase or in-phase and combined with one or more electrically passive materials. Different layers of the elongated polygon-shaped electrically active material layer 170 may have different shapes. For example, in a unimorph, a piezoelectric material may be shaped differently from a passive substrate material to which the piezoelectric material is bonded. The piezoelectric material, for example, piezoceramic, used in the electromechanically active device may be poled in any suitable manner, with polarization in any suitable direction.

In some implementations the polarization direction may be along the thickness of the piezoelectric material e.g., elongated polygon-shaped electrically active material layer 170). The polarization defines the direction along which the electric field is created in the piezoelectric material once a voltage is applied. The operation mode of the piezoelectric material may be based on how the piezoelectric material is integrated into and/or clamped to a structure. The piezoelectric material may be polarized in the direction of its thickness. As one of the surfaces of the piezoelectric material is polarized along its thickness, and because on one side of the piezoelectric material is attached to the elongated polygon transducer membrane 160, by applying the voltage across the top and bottom side of the piezoelectric material, it deforms and bends up and down (e.g., from a concave shape to a convex shape, and vice-versa).

The elongated polygon-shaped electrically active material layer 170 may be any suitable size for use in the ultrasonic transducer 150, and for vibrating at ultrasonic frequencies. The elongated polygon-shaped electrically active material layer 170 may be made in any suitable manner, such as, for example, by cutting polygon-shaped geometries from a larger laminate material. The laminate material may be made from, for example, an electrically active material, such a piezoceramic, bonded to an electrically inactive substrate, such as, for example, metals such as aluminum, Invar, Kovar, silicon/aluminum alloys, stainless steel, and brass, using any suitable bonding techniques and materials. The materials used may be non-optimal for the performance of an individual electromechanically active device. For example, materials may be selected for consistent performance across a larger number of electromechanically active device or for ease of manufacture.

The elongated polygon-shaped electrically active material layer 170 may be oriented at any suitable angle. The top surface of the elongated polygon-shaped electrically active material layer 170, which may be, for example, a passive material of a unimorph or an active material of a bimorph. The elongated polygon-shaped electrically active material layer 170 may be attached to the elongated polygon-shaped transducer elastic layer 160 of an ultrasonic transducer 150 in any suitable manner. For example, any sides of the elongated polygon-shaped electrically active material layer 170 may be bonded to the elongated polygon-shaped transducer elastic layer 160. The bonds used to secure the elongated polygon-shaped electrically active material layer 170 to the elongated polygon-shaped transducer elastic layer 160 may be any suitable combination of organic or inorganic bonds, using any suitable conductive and non-conductive bonding materials, such as, for example, epoxies or solders. The area of contact between the elongated polygon-shaped electrically active material layer 170 and the elongated polygon-shaped transducer elastic layer 160 may be any suitable size and shape. In some implementations, an ultrasonic transducer 150 may include more than one elongated polygon-shaped electrically active material layer 170. As shown in FIG. 10 as disclosed below, any number of ultrasonic transducers may be formed in any suitable arrangement.

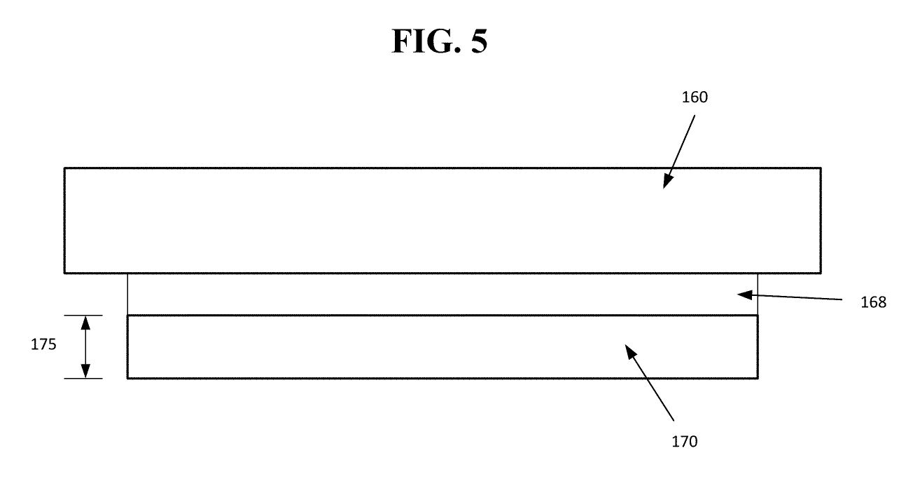

The elongated polygon-shaped electrically active material layer 170 may be bonded in a suitable position, with the passive or active layers of the elongated polygon-shaped electrically active material layer 170 facing down depending on whether the electromechanically active device is a unimorph, bimorph, trimorph, or has some other structure. The bond may use any suitable bonding agent, solder, or epoxy. For example, conductive adhesive film may be applied to the areas of the electromechanically active device to be bonded to the elongated polygon-shaped transducer elastic layer 160. For example, as shown in FIG. 5 and described below, the elongated polygon-shaped electrically active material layer 170 may be affixed to the elongated polygon-shaped transducer elastic layer 160.

As shown in FIGS. 1-2, the elongated polygon-shaped transducer elastic layer 160 may be bonded to the ultrasonic transducer 150 to create an ultrasonic device with a membrane. The elongated polygon-shaped transducer elastic layer 160 may be attached with adhesive in a manner that may define the outline of a number of cells of the electromechanical transducer array which the elongated polygon-shaped transducer elastic layer 160 will cover. The elongated polygon-shaped transducer elastic layer 160 may be multiple separate pieces of material. The elongated polygon-shaped transducer elastic layer 160 may act to acoustically couple the motion of cantilevers to the air, as the motion of cantilevers may cause the membrane to move.

The elongated polygon-shaped transducer elastic layer 160 may be any suitable material or composite material structure, which may be of any suitable stiffness and weight, for vibrating at ultrasonic frequencies. For example, the elongated polygon-shaped transducer elastic layer 160 may be both stiff and light. For example, the elongated polygon-shaped transducer elastic layer 160 may be aluminum shim stock, metal-patterned Kapton, or any other metal-pattern film. The elongated polygon-shaped transducer elastic layer 160 may be impedance matched with the air to allow for more efficient air-coupling of the ultrasonic transducers.

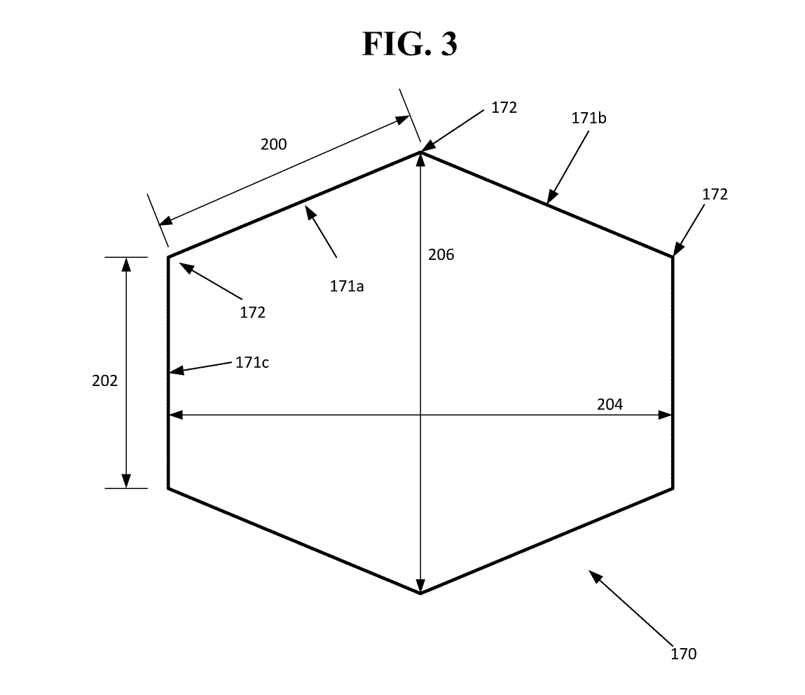

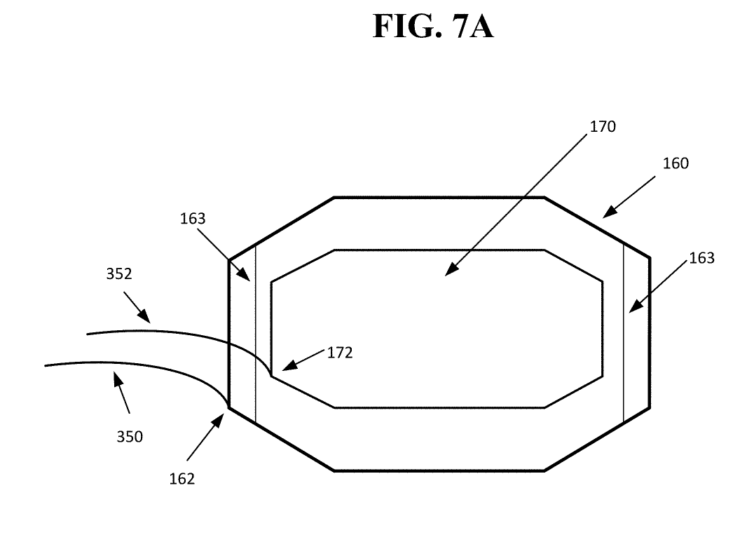

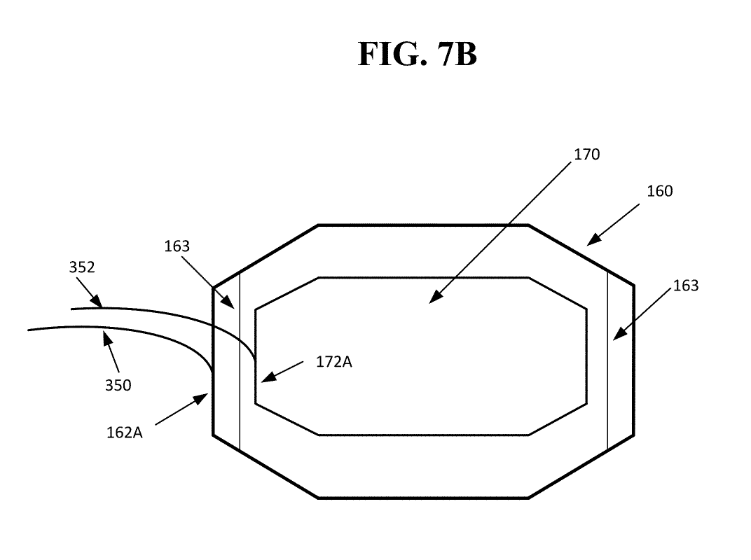

FIG. 3 shows the example elongated polygon-shaped electrically active material layer 170 of an ultrasonic transducer 150 according to an implementation of the disclosed subject matter. In some implementations of the disclosed subject matter, the example elongated polygon-shaped electrically active material layer 170 may be an elongated hexagon-shaped piezoelectric layer. That is, the electrically active material may be a piezoelectric material, a piezo-ceramic material, an electrostrictive material, a ferroelectric material, or any other suitable material. The polygon-shaped transducer elastic layer 170 may be formed of aluminum, silicon, brass, copper, nickel, titanium, steel, iron, magnesium, Invar, or any other suitable material, by an additive or a subtractive process. The elongated polygon-shaped electrically active material layer 170 may have a plurality of edges including edges 171a, 171b, and 171c. The elongated polygon-shaped electrically active material layer 170 may have a plurality of vertices 172, and an electrical connection (e.g., electrical connection 352 shown in FIGS. 7A-7B) at one of the plurality of vertices 172. In some implementations, there may be an electrical connection between two or more vertices. The elongated polygon-shaped electrically active material layer 170 may be disposed on the elongated polygon-shaped transducer elastic layer 160 to transform electrical excitation into a high-frequency vibration to produce ultrasonic acoustic emissions or transform received high-frequency acoustic vibration into electrical signals. A thickness 175 (e.g., shown in FIG. 5) of the elongated polygon-shaped electrically active material 170 may be 0.05-0.1 mm, 0.1-0.2 mm, 0.2-0.3 mm, 0.3-0.4 mm, 0.4-0.5 mm, or any other suitable thickness. In some implementations, the thickness 175 may be 0.15-0.25 mm. The polygon-shaped electrically active material layer 170 may have a thickness 175 so as to distribute stress from the polygon-shaped transducer elastic layer 170 substantially evenly throughout the polygon-shaped electrically active material layer 170. In some implementations, substantially even stress throughout the elastic layers means a stress variance of less than 40% throughout the layer. A length of a surface dimension (e.g., dimensions 200, 202, 204 and/or 206) of the elongated polygon-shaped electrically active material 170 may be 0.2-1 mm, 1.-5 mm, 5-10 mm, 10-15 mm, 15-20 mm, or any other suitable dimension. In some implementations, a length of dimension 206 may be longer than, but not equal to, dimension 204 so that the polygon-shaped electrically active material layer 170 has an elongated shape.

In some implementations, at least two of the edges (e.g., two of edges 171a, 171b and the like) of the polygon-shaped electrically active material layer 170 may have a greater length than that of other edges (e.g., edges 171c). The elongated polygon-shaped electrically active material layer 170 may have an aspect ratio, which may be the ratio of the longest surface (i.e., not thickness) dimension to the shortest surface (i.e., not thickness) dimension of the elongated polygon-shaped electrically active material layer 170. For example, the aspect ratio may be the ratio of dimension 200 to dimension 202, or from dimension 204 to dimension 206. In some implementations of the disclosed subject matter, the aspect ratio may be 1.03:1-2:1, 2:1-3:1, 3:1-4:1, 4:1-5:1, or any other suitable aspect ratio. For example, the ratio range 2:1-3:1 may include aspect ratios of such elongated polygon-shaped electrically active material layer 170 as 2.5:1. In some implementations, the aspect ratio may be 1.03:1-2:1.

FIG. 4 shows a bottom view of the ultrasonic transducer 150 that includes the elongated polygon-shaped transducer elastic layer 160 and the elongated polygon-shaped electrically active material layer 170 according to an implementation of the disclosed subject matter. The elongated polygon-shaped transducer elastic layer 160 may have a plurality of edges 161, a plurality of vertices 162, and a first electrical connection (350 shown in FIGS. 7A-7B) at or near one of the first plurality of vertices. Each of the vertices 162 may be disposed at the intersection between the edges 161. The elongated polygon-shaped transducer elastic layer 160 may be formed by any additive or subtractive process from aluminum, monocrystalline silicon, amorphous silicon, brass, Invar, titanium, nickel, steel, iron, magnesium, copper, and/or any other suitable material.

The elongated polygon-shaped transducer elastic layer 160 may be coupled to a support structure 163. The elongated polygon-shaped transducer elastic layer 160 may fixed to the support structure 163 at or around a plurality of the vertices 162 and not fixed to the support structure at more than 50% of the perimeter that may include the edges 161. The elongated polygon-shaped electrically active material layer 170 may be affixed to the elongated polygon-shaped transducer elastic layer 160.

In some implementations, the elongated polygon-shaped transducer elastic layer 160 may be coupled to the elongated polygon-shaped electrically active material layer 170, where a shape of the elongated polygon-shaped transducer elastic layer 160 and the elongated polygon-shaped electrically active material layer 170 may be the same.

FIG. 5 shows a side view of an example ultrasonic transducer that includes the elongated polygon-shaped transducer elastic layer 160 and an elongated polygon-shaped electrically active material layer 170 according to an implementation of the disclosed subject matter. The elongated polygon-shaped electrically active material layer 170 may be affixed to the elongated polygon-shaped transducer elastic layer 160 by adhesive layer 168. Although the adhesive layer 168 by be any suitable bonding agent and/or adhesive, the adhesive layer may also be solder or other material used to weld together the elongated polygon-shaped electrically active material layer 170 and the elongated polygon-shaped transducer elastic layer 160.

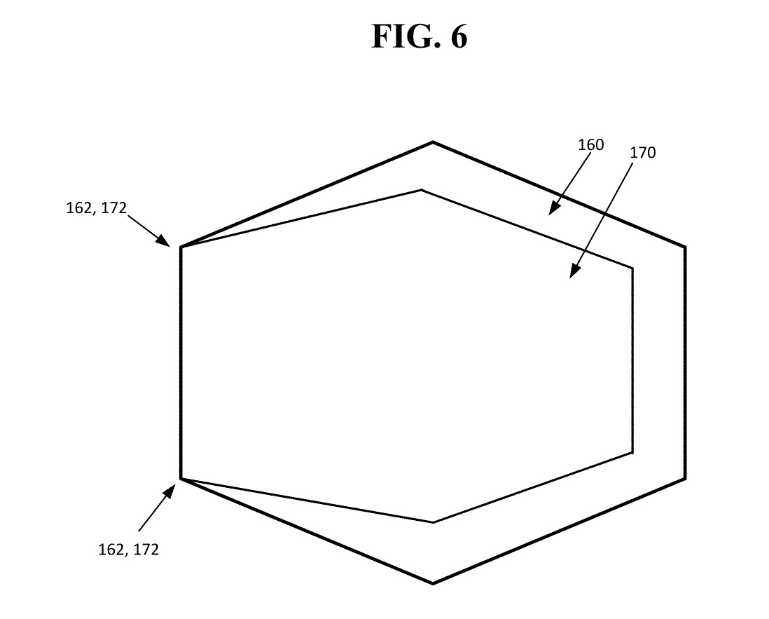

FIG. 6 shows a bottom view of an example an ultrasonic transducer that includes the elongated polygon-shaped transducer elastic layer 160 and the elongated polygon-shaped electrically active material layer 170 according to an implementation of the disclosed subject matter. The elongated polygon-shaped electrically active material layer 170 may be bonded at or near the tip of the elongated polygon-shaped transducer elastic layer 160. The elongated polygon-shaped electrically active material layer 170 may be fixed to the elongated polygon-shaped transducer elastic layer 160 at or near (e.g., within 0.5 mm-5.0 mm) at least one of the plurality of vertices 162 and the plurality of vertices 172. In some implementations, the polygon-shaped electrically active material layer 170 may be fixed to the elongated polygon-shaped transducer elastic layer 160 at or within a range of 0.5 mm-5.0 mm of at least one of the plurality of vertices 162 and the plurality of vertices 172.

FIGS. 7A-7B show electrically conductive members 350, 352 coupled to the elongated polygon-shaped transducer elastic layer 160 and elongated polygon-shaped electrically active material layer 170 according to implementations of the disclosed subject matter. As shown in FIG. 7A, the elongated polygon-shaped transducer elastic layer 160 may have the electrically conductive member 350 coupled at an electrical connection at or near one of the plurality of vertices 162. The electrically conductive member 350 may be coupled to at least one of the plurality of vertices 162 at which elongated polygon-shaped transducer elastic layer 160 is fixed to the support structure 163. The elongated polygon-shaped electrically active material layer 170 may have electrically conductive member 352 coupled at an electrical connection at one of the plurality of vertices 172. The electrically conductive member 350 may be used at least in part so the elongated polygon-shaped electrically active material layer 170 and/or elongated polygon-shaped transducer elastic layer 160 may transform electrical excitation into a high-frequency vibration to produce ultrasonic acoustic emissions. The first and second electrical connections at or near (e.g., 0.1-2 mm) the vertices 162, 172 include a first electrode and a second electrode to which the electrically conductive members 350, 352 are respectively coupled. In some implementations, such as those shown in FIG. 7A, the first and second electrical connections at or within 0.1-2 mm of the vertices 162, 172. In some implementations, such as those shown in FIG. 7B, the electrically conductive member 350 may be connected at or near a center of edge 162A, and the electrically conductive member 352 may be connected at or near a center of an edge.

The first electrode and the second electrode to which the electrically conductive members 350, 352 may be disposed at respective locations of the polygon-shaped transducer elastic layer 160 and the polygon-shaped electrically active material layer 170 which have less deflection that other locations of the polygon-shaped transducer elastic layer 160 and the polygon-shaped electrically active material layer 170.

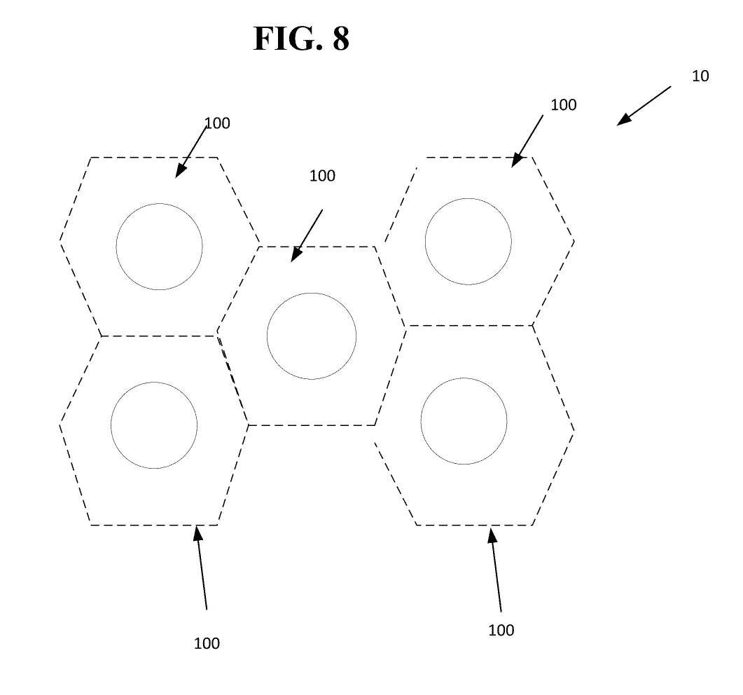

FIG. 8 shows an example transducer array according to an implementation of the disclosed subject matter. An electromechanical transducer array may include any number of ultrasonic transducers. The ultrasonic transducers may share a common piece of material as a substrate, or may use any suitable number of separate pieces of material, for example, with each ultrasonic transducer having its own separate piece of substrate material. The ultrasonic transducers of an electromechanical transducer array may be divided into cells. Each cell may include a single ultrasonic transducer covered by a membrane or membrane section, or may include multiple ultrasonic transducers. The cells may be any suitable shape, in any suitable pattern. Each cell shape may be any suitable polygon, and may be arranged in any suitable pattern. For example, as shown in FIG. 8, the transducer array 10 may include a plurality of the apparatus 100 shown in FIGS. 1A-2B and disclosed above that include ultrasonic transducers. The ultrasonic transducers may be arranged in any suitable manner, such as, for example, in a grid pattern.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. An apparatus comprising:
an elongated hexagon-shaped transducer elastic layer having a first plurality of edges, a first plurality of vertices, and a first electrical connection at or near one of the first plurality of vertices; and
an elongated hexagon-shaped piezoelectric layer having a second plurality of edges, a second plurality of vertices, and a second electrical connection at or near one of the second plurality of vertices, wherein the elongated hexagon-shaped piezoelectric layer is disposed on the elongated hexagon-shaped transducer elastic layer to transform electrical excitation into a high-frequency vibration to produce ultrasonic acoustic emissions or transform received high-frequency acoustic vibration into electrical signals,
wherein a thickness of the elongated hexagon-shaped piezoelectric layer is 0.15-0.25 mm, and
wherein a length of at least one surface dimension of the elongated hexagon-shaped piezoelectric layer is 0.2-20 mm.

2. The apparatus of claim 1, wherein the elongated hexagon-shaped piezoelectric layer is fixed to the elongated hexagon-shaped transducer elastic layer at or near at least one of the first plurality of vertices and at or near one of the second plurality of vertices.

3. The apparatus of claim 1, wherein the elongated hexagon-shaped piezoelectric layer is attached to the elongated hexagon-shaped transducer elastic layer with an adhesive.

4. The apparatus of claim 3, wherein the elongated hexagon-shaped piezoelectric layer is attached to the elongated hexagon-shaped transducer elastic layer with the adhesive at or near one or more of the first plurality of vertices and one or more of the second plurality of vertices.

5. The apparatus of claim 1, wherein a size of the elongated hexagon-shaped piezoelectric layer is 60%-90% of the elongated hexagon-shaped transducer elastic layer.

6. The apparatus of claim 1, wherein an aspect ratio of the elongated hexagon-shaped piezoelectric layer is 1.03:1-2:1.

7. The apparatus of claim 1, wherein at least two edges of the plurality of edges of the hexagon-shaped piezoelectric layer have a greater length than that of the other edges of the plurality of edges.

8. The apparatus of claim 1, wherein the hexagon-shaped piezoelectric layer has a thickness so that stress from the transducer-shaped transducer elastic layer is distributed substantially evenly throughout the hexagon-shaped piezoelectric layer.

9. The apparatus of claim 1, wherein the first and second electrical connections at or near one of the first plurality of vertices and at or near one of the second plurality of vertices comprise a first electrode and a second electrode, respectively.

10. The apparatus of claim 9, wherein the first electrode and the second electrode are disposed at respective locations of the hexagon-shaped piezoelectric layer and the hexagon-shaped electrically active material layer which have less deflection that other locations of the hexagon-shaped transducer elastic layer and the hexagon-shaped piezoelectric layer.

11. An apparatus comprising:
an elongated polygon-shaped transducer elastic layer having a first plurality of edges, a first plurality of vertices, and a first electrical connection at one of the first plurality of vertices; and
an elongated polygon-shaped electrically active material layer having a second plurality of edges, a second plurality of vertices, and a second electrical connection at one of the second plurality of vertices, wherein the elongated polygon-shaped electrically active material layer is disposed on the elongated polygon-shaped transducer elastic layer to transform electrical excitation into a high-frequency vibration to produce ultrasonic acoustic emissions or transform received high-frequency acoustic vibration into electrical signals.

12. The apparatus of claim 11, wherein a thickness of the elongated polygon-shaped electrically active material layer is 0.15-0.25 mm.

13. The apparatus of claim 11, wherein a length of at least one surface dimension of the elongated polygon-shaped electrically active material layer is 0.2-20 mm.

14. The apparatus of claim 11, wherein the elongated polygon-shaped electrically active material layer is fixed to the elongated polygon-shaped transducer elastic layer at or near at least one of the first plurality of vertices and one of the second plurality of vertices.

15. The apparatus of claim 11, wherein the elongated polygon-shaped electrically active material is selected from the group consisting of: a piezoelectric material, a piezo-ceramic material, an electrostrictive material, and a ferroelectric material.

16. The apparatus of claim 11, wherein the elongated polygon-shaped transducer elastic layer is coupled to the elongated polygon-shaped electrically active material layer, and
wherein a shape of the elongated polygon-shaped transducer elastic layer and the elongated polygon-shaped electrically active material layer are the same.

17. The apparatus of claim 11, wherein the polygon-shaped electrically active material layer has a thickness so as to distribute stress from the polygon-shaped transducer elastic layer evenly throughout the polygon-shaped electrically active material layer.

18. The apparatus of claim 11, wherein the first and second electrical connections at or near one of the first plurality of vertices and at or near one of the second plurality of vertices comprise a first electrode and a second electrode, respectively.

19. The apparatus of claim 18, wherein a wire or electrically conductive member is disposed between the first electrode and the second electrode.

20. The apparatus of claim 18, wherein the first electrode and the second electrode are disposed at respective locations of the polygon-shaped transducer elastic layer and the polygon-shaped electrically active material layer which have less deflection that other locations of the polygon-shaped transducer elastic layer and the polygon-shaped electrically active material layer.

21. The apparatus of claim 11, wherein an aspect ratio of the polygon-shaped electrically active material layer is 1.03:1-2:1.

22. The apparatus of claim 11, wherein at least two of the edges of the polygon-shaped electrically active material layer have a greater length than that of the other edges of the plurality of edges.

23. The apparatus of claim 11, wherein the polygon-shaped transducer elastic layer is formed of at least one from the group consisting of: aluminum, silicon, brass, copper, nickel, titanium, steel, iron, magnesium, and Invar.

24. The apparatus of claim 11, wherein the polygon-shaped transducer elastic layer has a first surface and a second surface, and is coated on at least one of the first surface and the second surface with an electrically conductive material.
